(19) United States
(12) Patent Application Publication
(10) Pub. No.: US 2003/0046697 A1
(43) Pub. Date: Mar. 6, 2003

(54) Method and system for distribution of electronic magazines and publications

(75) Inventor: Hiroaki Shinohara, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(73) Assignee: Sony Corporation

(21) Appl. No.: 09/813,192

(22) Filed: Mar. 20, 2001

Related U.S. Application Data
(60) Provisional application No. 60/248,512, filed on Nov. 13, 2000.

(51) Int. Cl. H04N 5/445; G06F 3/00; G06F 13/00; H04N 7/173; H04N 7/16

(52) U.S. Cl. 725/51; 725/112; 725/135

(57) ABSTRACT

Electronic publications are entirely in digital form and are not distributed in hard-copy form. Consequently, distribution can occur by virtually any data transmission. In fact, the electronic publications can be incorporated in a television signal broadcast by a broadcasting system (cable, satellite, terrestrial). The publication is then extracted from the television signal by a receiving or recording device, such as a personal video recorder. The publication can then be displayed and read on the user's television set or other video monitor. In this way, electronic publications can be distributed widely and quickly at little cost.

### RELATED APPLICATIONS

The present application claims priority under 35 U.S.C. § 119 of a previous U.S. provisional patent application, Application No. 60/248,512 filed Nov. 13, 2000 and entitled “System and Method for Electronic Magazine Distribution.” Application No. 60/248,512 is hereby incorporated by reference in its entirety.

### FIELD OF THE INVENTION

The present invention relates to the field of publishing. More particularly, the present invention relates to a novel system and method of distributing electronic magazines and other publications using television broadcasting systems in parallel with the Internet. The present invention provides a system and method of downloading electronic publications to subscribers using, for example, a personal video recorder receiving data from a television broadcasting system and, possibly, from the Internet.

### BACKGROUND OF THE INVENTION

The traditional world of publishing, in which publications such as books and magazines are produced on paper, is being challenged by new electronic media, particularly the Internet. Traditionally, in order to reach a relatively large audience, written material had to be accepted by a publishing company and then produced in print. In this conventional model, written material is mass printed on paper or some other hard-copy medium. The publication is then physically distributed to purchasers and subscribers through distribution networks and retail outlets.

In contrast, it is now possible to reach a very wide audience with an electronic publication distributed via, for example, the Internet. An electronic publication is not produced or distributed on paper, but is transmitted electronically as a file of digital data. The electronic publication can contain the elements of a traditional publication such as text, graphics and photographs. However, unlike traditional print media, an electronic publication can also contain motion picture video, audio and other active elements. The traditional, inactive elements of the electronic publication, e.g., text, graphics and photographs, can, of course, be printed in hardcopy form by purchasers or subscribers as desired. This is typically done using a printer as a peripheral to the computer on which the purchaser or subscriber has received and accessed the electronic publication.

Consequently, electronic publishing provides the opportunity to more quickly produce and disseminate a widely-read publication. Moreover, electronic publishing drastically reduces the cost of producing such a publication, thereby providing the opportunity for smaller enterprises to produce and market a publication. Publishing need no longer be the exclusive province of large publishing firms.

As described above, electronic publications are frequently distributed over the Internet. However, not everyone has access to or feels comfortable using the Internet. Moreover, some subscribers may not wish to take the time to access the Internet and download electronic publications. Alternatively, electronic publications can also be distributed on a floppy or optical disk and by other electronic means. However, this means of distribution has most of the disadvantages of distributing the publication in traditional hardcopy form.

Consequently, there is a need in the art for a method and system that complements the Internet as a means of distributing electronic publications.

### SUMMARY OF THE INVENTION

The present invention meets the above-described needs and others. Specifically, the present invention provides a method and system that complements the Internet or other data network as a means of distributing electronic publications.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as a television signal that includes both television programming; and an electronic publication so that the electronic publication is distributed by broadcast of the television signal. The television signal may be digital or analog with the data of the electronic publication being converted and encoded as needed to provide a digital file of the data of the publication to the end user.

The electronic publication may also provide features which are not available in conventional publications such as one or more hyperlinks referencing an Internet or other network site. The electronic publication may also include an embedded video or audio clip.

The present invention may also be embodied in a system for distributing an electronic publication, that includes a television signal broadcasting headend, where the television signal broadcast from the headend includes both television programming and an electronic publication; and a personal video recorder for extracting the electronic publication from the television signal for use by a user. The personal video recorder preferably includes a digital data storage device for recording the electronic publication. This storage device is preferably a hard disk drive. The broadcasting headend may include a subscriber billing system for tracking distribution of electronic publications and billing recipients for the electronic publications.

The personal video recorder also preferably provides a connection to the Internet and an Internet browser, or a connection to another electronic data network. In this way, if the electronic publication further includes a hyperlink referencing a site on the Internet or other network, the personal video recorder can access the referenced site. Preferably, a remote control unit or other user input device (such as a keypad, keyboard, mouse, trackball, joystick, etc.) is used for controlling the personal video recorder to access and output the electronic publication to a video monitor connected to the personal video recorder. The personal video recorder may also provide an external data connection for downloading the electronic publication to a computer or personal digital assistant.

The present invention also encompasses the methods of making and operating the system described above. Specifically, the present invention encompasses a method of distributing an electronic publication by incorporating data for the electronic publication in a television signal along with television programming; and broadcasting the television signal to users.

The present invention also encompasses a second system for distributing an electronic publication. This system includes an interactive television device for providing access to both broadcast television channels and sites on the Internet or other network, where the interactive television device includes web browsing and video software for receiving streamed data from the Internet; and a connection for connecting the interactive television device and the Internet. This system may further include an electronic publication resident at an Internet site accessible to the interactive television device. In this model, the electronic publication is streamed to the interactive television device via the Internet.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is an illustration of a first embodiment of the present invention including a system of distributing electronic publications using a television broadcasting system and a personal video recorder.

FIGS. 2a and 2b are diagrams illustrating the operation of the personal video recorder of FIG. 1 in receiving and utilizing electronic publications.

FIG. 3a is an illustration of a system according to the present invention for distributing electronic publications through a number of parallel distribution channels.

FIG. 3b is an illustration of the revenue generating system that operates with the distribution system of FIG. 3a.

FIG. 4 illustrates an exemplary page of an electronic publication distributed, for example, using the present invention.

FIG. 5 illustrates a second embodiment of the present invention including an interactive television system used to receive and utilize electronic publications.

### DETAILED DESCRIPTION OF THE PREFERRED EMBODIMENTS

Under the principles of the present invention, an electronic publication can be distributed in a television signal broadcast by a television broadcasting system. This distribution may be the sole means of disseminating the publication, or may be used to supplement distribution via the Internet and other means. The television broadcasting system distributing the electronic publication can be a conventional terrestrial broadcaster, a cable television system, a satellite broadcasting system or any other broadcasting system. The digital file comprising the electronic publication is encoded (if necessary) and transmitted via the television broadcasting system to a receiver, such as a personal video recorder operated by the publication's subscriber or purchaser.

Personal Video Recorders (“PVRs”) have developed as an improvement to the conventional Video Cassette Recorder (“VCR”). Current television broadcasting system can provide subscribers with dozens or hundreds of channels of television programming. With so much programming available, it may be difficult for a viewer to be available to watch all the programming he or she wishes to see at the times those programs are broadcast. Consequently, recording devices have been developed to record broadcast television signals. In this way, the viewer can “time-shift” a program by recording the program when it is broadcast, and then replaying it for viewing at a time convenient to the viewer. These recording devices may be generally categorized as Video Cassette Recorders (VCRs) and Personal Video (or Versatile) Recorders (“PVRs”).

A VCR uses a magnetic tape to allow the user to record incoming audiovisual programming while watching the same or a different channel. A timer in the VCR allows the user to record broadcast programming according to a pre-programmed recording schedule. As mentioned above, the recording is then available for playback at the user's convenience.

The basic concept of the VCR has been extended to digital compression devices that provide even more features for managing the reception and recording of audiovisual programming. These products have a number of names such as personal television products, personal video recorders, video recording computers, personal television servers, etc. (referred to collectively as “personal video recorders” or “PVRs” hereafter). Current examples of personal video recorders include the TiVo® system made by TiVo, Inc. and the ReplayTV® system made by Replay Networks, Inc.

Personal video recorders replace the video cassette in a VCR with a hard disk drive or other digital memory device of comparable capacity. Typically, this memory is internal to the personal video recorder. The personal video recorder is connected between a user's television set and that user's set-top box, satellite receiver or antenna. The personal video recorder can control the channel tuned on the television, provide an interactive electronic program guide and record programming on a manual or timer-controlled basis. Additionally, the personal video recorder can buffer incoming audiovisual programming so that the viewer can pause a live television program or replay a portion of a live television program without missing any subsequent segment of the program, as long as the pause or replay does not exceed the capacity of the buffer.

Because the personal video recorder records in a digital format on a digital recording medium, e.g. a hard disk drive, the personal video recorder is much more amenable than a VCR to capturing high-quality, digital television signals. Additionally, under the principles of the present invention, a PVR can be used to receive a digital transmission of an electronic publication. The digital data file comprising the publication is transmitted to the PVR using whatever television signal broadcasting system the PVR typically receives.

Using the drawings, the preferred embodiments of the present invention will now be explained.

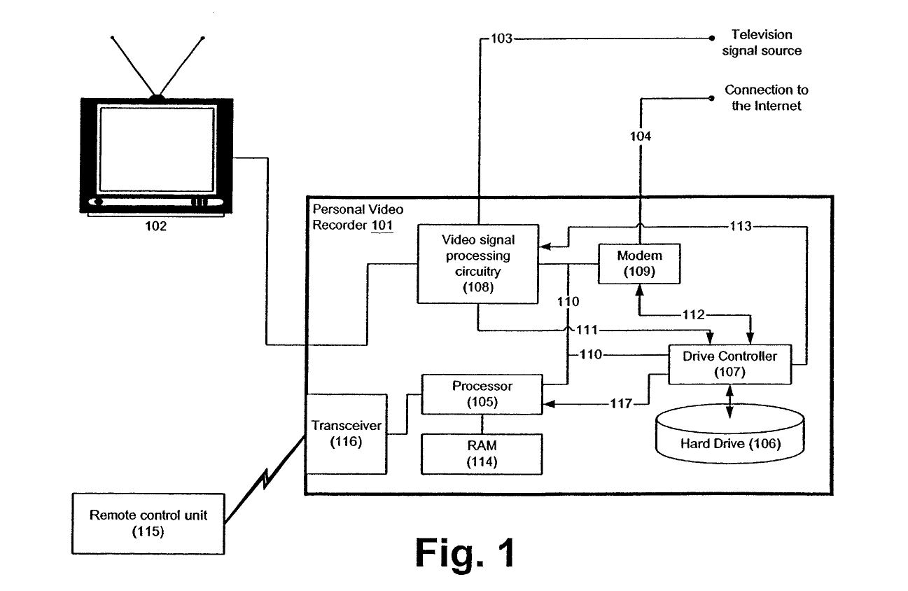

FIG. 1 illustrates a first embodiment of the present invention including a system of distributing electronic publications using a television broadcasting system and a personal video recorder. As shown in FIG. 1, a person video recorder (PVR) (101) is connected to a television set or video monitor (102). The PVR (101) is connected to a television signal source (103). This television signal source may be a cable or satellite television system, an antenna for terrestrial television broadcasts or any other television signal source.

The television signal incoming from the connection to the signal source (103) is processed through video signal processing circuitry (108). This circuitry (108) may include one or more tuners for tuning a particular channel from the television signal, a video decoder, and any other processing circuitry necessary for outputting a video signal for use by the monitor (102) from the television signal from the signal source (103).

The video signal processing circuitry (108) is controlled by a processor (105) of the PVR (101). The processor (105) controls the various elements of the PVR (101) by executing programming from a Random Access Memory (RAM) unit (114). A control bus (110) connects the processor (105) and the key components of the PVR (101), including the video signal processing circuitry (108).

A user may control the PVR (101) with a remote control unit (115). The remote control unit (115) transmits a wireless signal to a transceiver (116) in the PVR (101). The input from the remote control unit (115) is provided by the transceiver (116) to the processor (105).

The PVR (101) also has substantial digital memory in which to record television programming and other digital data. In the example of FIG. 1, the PVR (101) includes a hard disk drive (106) which is controlled by a drive controller (107). Data can be written to or retrieved from the hard drive (106) through the controller (107). For example, the processor (105) may cause the video processing circuitry (108) to output a video signal (111) to the drive controller (107). The drive controller (107) can then compress the signal and record it on the hard drive (106) for later retrieval. Programming for the processor (105) may also be recorded on the hard drive (106).

The drive controller (107) is also connected to the control bus (110) and can be controlled by the processor (105) to retrieve data. Data from the hard drive (106) can be provided to the processor (105) via connection (117). Additionally, a recorded video signal, for example, can be retrieved from the hard disk (106) and output (113) to the video processing circuitry (108) and, ultimately, to the video monitor (102).

Finally, the PVR (101) may also have a connection to the Internet (104) or other electronic network. This connection may be used to obtain information to supplement an electronic publication distributed to and stored on the PVR (101) as will be described in more detail below. This network may be the Internet or any other electronic network to which the PVR (101) is connected. As used herein, the term “network” shall refer broadly to any network over which digital data can be transmitted. This would include, but is not limited to, a global computer network such as the Internet and World Wide Web, a local area network (LAN), a wide area network (WAN), a cable television network, etc.

The connection to a television signal source (103) and the supporting network (104) may be carried by the same wire or cable, or may be different connections. The connection to the Internet (104) or other network may be routed through a modem (109), preferably a DSL or cable modem. The modem (109) is also controlled by the processor (105) using the control bus (110). The modem (109) can output data (112) to the drive controller (107) for recording on the hard drive (106); and can receive data from the drive (106) for transmission over the network (104).

Under the principles of the present invention, the PVR (101) is also used to receive and utilize electronic publications. Specifically, the digital data file that constitutes an electronic publication can be transmitted from the television signal source (103) to the PVR (101). The electronic publication can then be stored on the hard drive (106) and perused at the convenience of the user.

For example, the user may be controlling the PVR (101) with the remote control unit (115). A menu of available recorded programming and received electronic publications can be output by the PVR (101) and displayed on the monitor (102). The user may then, through the remote control unit (115) select the electronic publication from the displayed menu. When selected, the publication is retrieved from the hard drive (106) and displayed by the PVR (101) on the monitor (102). The user can then scroll through each page of the publication and page through the publication using the remote control unit (115) to control the display of the publication on the monitor (102).

Under the principles of the present invention, an electronic publication can be transmitted on an incoming television signal regardless of whether that signal is analog or digital. In either case, the digital data of the publication can be encoded in the television signal. The video signal processing circuitry (108) will include the necessary decoding and conversion circuitry to recover the digital data file of the electronic publication from the television signal.

In one preferred embodiment, the electronic publication is broadcast over the television broadcasting system late at night or early in the morning when the demands on the broadcasting system are at a minimum. In such a case, the PVR being used to capture the publication can be programmed to power up and tune the appropriate channel to receive the publication at the appropriate time. A timer system similar to that of a VCR is already a part of typical PVRs. Alternatively or additionally, there may be a dedicated television channel or channels on which the data of electronic publications is broadcast.

Additionally, the PVR (101) with a connection (104) to the Internet or other data network may also receive electronic publications by downloading them from the network. Also, an electronic publication received from the television signal source (103) by the PVR (101) may include hyperlinks that specify particular sites on the World Wide Web, Internet or other data network where additional or related information or activities can be found. These hyperlinks typically operate by specifying a Universal Resource Locator (URL) on the Internet. The PVR (101) can then allow the user who is reading an electronic publication to select a hyperlink. The PVR (101) then uses the modem (109) and connection (104) to the Internet or other network to access the site specified by that hyperlink. Consequently, the two methods of distributing electronic publications, television broadcasting system and Internet, can complement each other.

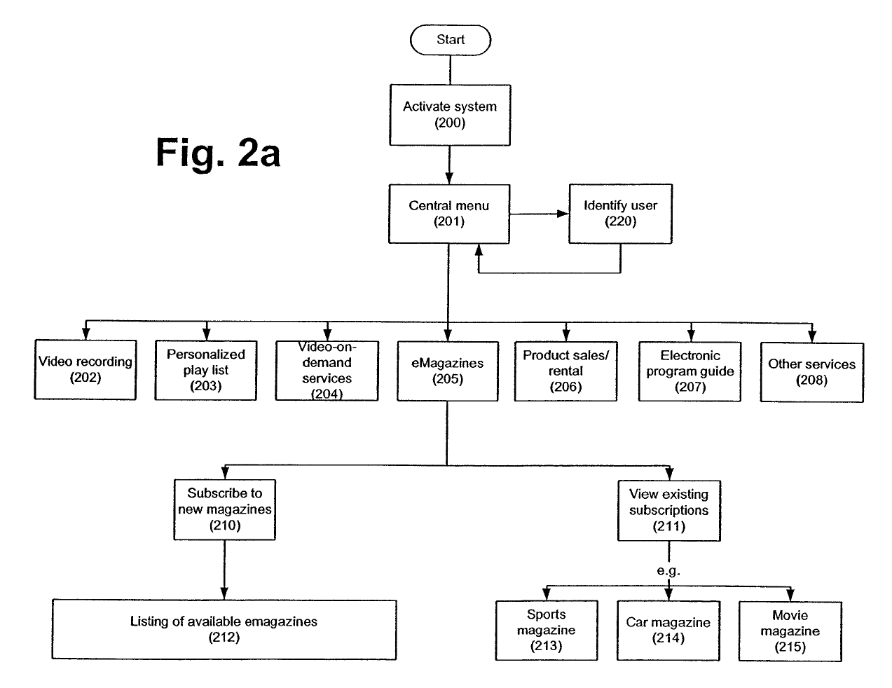

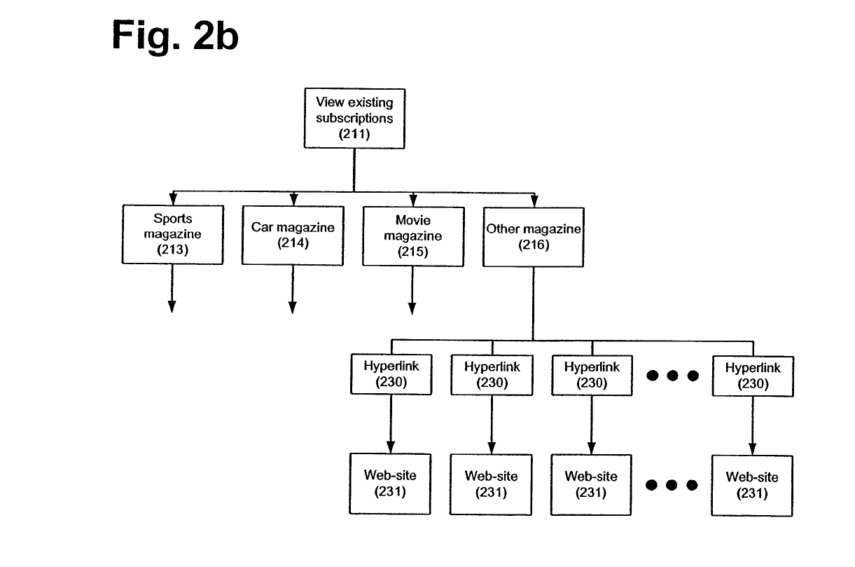

FIG. 2a illustrates a hierarchical structure of the functions that may be provided by the PVR (101), including subscribing to and receiving electronic publications. In the example of FIG. 2a, electronic magazines are the electronic publications being received.

As shown in FIG. 2a, the PVR (101) is first activated (200) and then may provide a central menu (201) from which the desired service can be selected. In one preferred embodiment, the PVR may allow the user to specify his or her identity (220). The PVR will then display a central menu (201) based on the expressed preferences or limitations pre-set for that user.

The next row of blocks in FIG. 2a illustrates some of the services of the PVR that may be accessed from the central menu (201). These include watching and recording television programming (202), accessing a personalized playlist of audio or video programming (203), ordering video-on-demand services (204), reading or obtaining an electronic publication (e.g., an electronic magazine or eMagazine) (205); shopping for product purchases or rentals (206); accessing an electronic programming guide (207) and other services (208). The services provided by the PVR are not limited under the principles of the present invention.

If electronic publication services are selected, the user has the choice of subscribing to or ordering new publications (210) or reading publications that have already been received (211). If the user wishes to order a new publication, e.g., subscribe to a new eMagazine, a listing of available publications is provided (212). The user can then select the publication desired and place an order. The listing of available publications can be downloaded to the PVR from the Internet or other data network, or over the television broadcasting system.

If the user accesses received publications (211), the PVR may then provide the user with a listing of the received publications from which the desired publication can be selected. In the example of FIG. 2a, the user has subscribed to a number of eMagazines (213-215) and can select from among them. The selected magazine is then retrieved and displayed under the user's control on the attached monitor.

FIG. 2b illustrates the idea that each or any of these magazines, or any other type of electronic publication, may include hyperlinks (230). In FIG. 2b, a generic publication or eMagazine (216) is illustrated as containing a number of hyperlinks (230). Each hyperlink (230), if selected, points browser software in the PVR to a particular site on a network, for example a URL or web-site (231) on the Internet. Thus, the electronic publication can incorporate additional material and interactive network- and web-sites by referencing those sites in hyperlink form. The PVR then exploits its connection to the Internet or other network to capture the referenced material for the user.

While a PVR has been described above as the means for receiving and reading electronic publications distributed by a television broadcaster, the functionality and not the identity of the unit as a PVR is important to the principles of the invention. As used throughout this document, the terms “personal video recorder” and “PVR” shall refer broadly to any electronic device or component of an electronic device that records an incoming television signal on a hard disk drive or other digital data storage device.

For example, many cable television systems use a Set-Top Box (“STB”) as an electronic interface between the cable system and the user's television set. An STB could incorporate a data storage device, such as a hard drive, and could be designed or modified to perform all the functions described above as being performed by a PVR. In such a case, that STB could be used to implement the present invention in the same manner described above. Additionally, the PVR may be integrated into a single unit with a television set rather than being a separate box of electronics.

Consequently, the term personal video recorder or PVR must be interpreted broadly to include any device that receives and processes television signals and can record digital data so that an electronic publication can be incorporated in the incoming television signal and extracted, stored and used by the receiving device, e.g., a PVR, STB or the like.

Additionally, it should be noted that while a connection to a supporting data network, such as the Internet, is preferable and, for some features, required, the present invention does not require a PVR or like device that is connected to the Internet or other data network. Rather, the PVR or like device may simply receive electronic publications from a television signal broadcaster without supplementing the publication with access to an electronic data network.

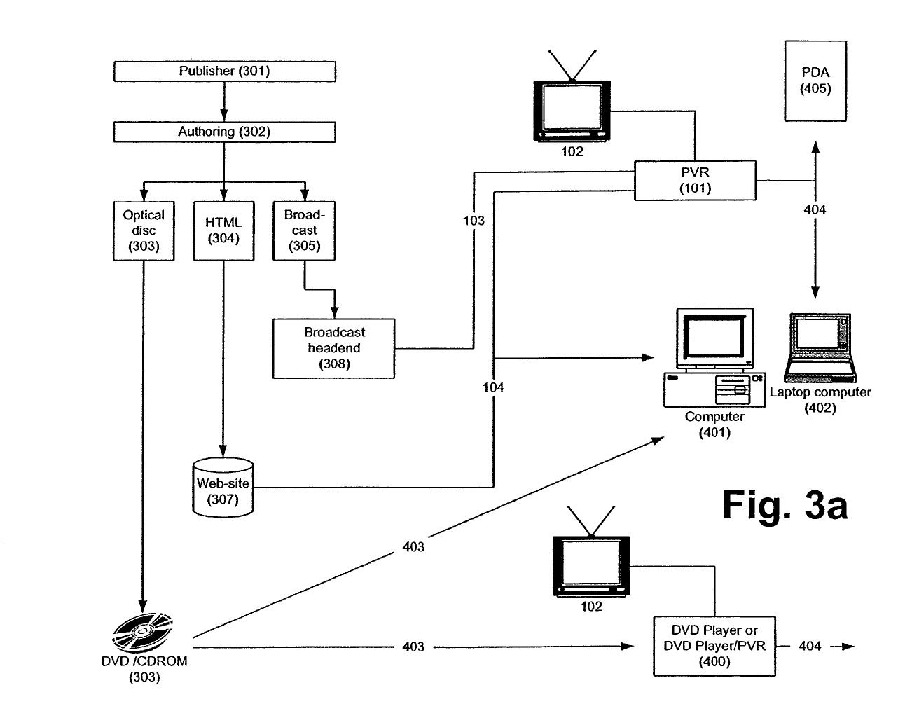

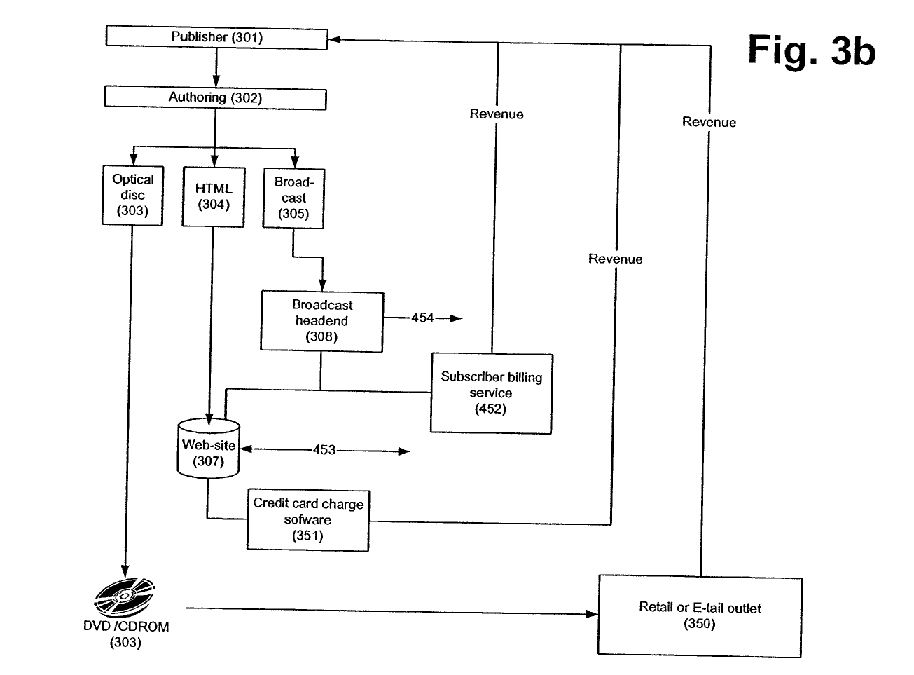

FIG. 3a illustrates the various methods of distributing electronic publications, including the novel methods of the present invention, and illustrates how these methods may supplement each other. As shown in FIG. 3a, a publisher (301) produces the content of the electronic publication. The material is then authored (302) into an electronic publication.

The publication may take several forms. For example, the digital file or files that constitute the publication may be stored on a disk (303), e.g. an optical disk such as a DVD, CD or CD-ROM or a floppy disk. The digital file may also be stored on a removable semiconductor memory card. In this scenario, the removable medium on which the publication is stored is distributed (403) directly to purchasers or subscribers. The user then accesses the publication using the appropriate equipment. For example, if the publication is distributed on a DVD, the user places the DVD (303) in a DVD player (or a combination PVR/DVD player) (400) and accesses the publication. Alternatively, if the publication is on a floppy disk, CD or CD-ROM, the user places the disk in a desk-top computer (401) or laptop computer (402) and accesses the publication.

In another form, the publication may be rendered using Hyper-Text Markup Language (HTML) (304). The publication is then placed on a network site to which the PVR has access, for example a web-site (307) on the Internet. The publication may be displayed at the web-site or may be a file in some form other than HTML for downloading from the web-site. The purchaser or subscriber then accesses the web-site (307) using a computer (401, 402) with access to the Internet (104) and the web-site (307). The publication is then downloaded to the computer (401, 402). Additionally, if the user has a PVR (101) with an Internet connection (104), the user can download the publication from the web-site (307) using the PVR (101).

Finally, under the principles of the present invention, the digital data that makes up the publication can be incorporated in a broadcast television signal (305). The signal is then broadcast from a broadcast headend (308). The broadcast system may be any of those described above. The user's PVR (101), connected physically or wirelessly, to the headend (308), receives the signal, extracts the data of the electronic publication and provides the publication to the user in the manner described above. Additionally, the PVR (101) may have external connections (404) so that the data of the electronic publication can be transferred to a computer (401, 402) or a personal digital assistant (PDA) (405) for use by the user.

FIG. 3b illustrates the revenue flow model for the various methods of distributing an electronic publication using the distribution channels illustrated in FIG. 3a. In the case of removable media (303), e.g., a DVD, CD-ROM or floppy disk, the media may be purchased from a retail outlet with revenue being provided to the publisher when the retail outlet purchases a supply of the publication for sale. Similarly, a user may order the publication from a web-site (an e-tailer) or place a phone order and have the media mailed or shipped to the user. Intermediate providers will provide revenue to the purchaser when acquiring a supply of the publication for sale. Alternatively, the publisher may take direct phone or Internet orders for the publication and receive revenue directly from purchasers or subscribers.

If the electronic publication is distributed over the Internet from a web-site (307) or other Internet site, the operator of the web-site may charge the credit card of a purchaser using an appropriate system (351) before downloading the data of the publication to the purchaser via an Internet connection (453). Alternatively, the web-site may create a subscriber system in which the user is billed based on the publications or number of publications downloaded. A subscriber billing service (452) that monitors the user's activity on the web-site (307) can be used track the service provided and bill the user accordingly. Revenue received from the billing service (452) is then provided in whole or in part to the publisher (301), depending on whether the billing service (452) is operated by the publisher (301) or an independent enterprise.

Finally, if the electronic publication is distributed over a television broadcast system (305, 308), the user receives the publication in the broadcast signal (454). A billing service (452) is then preferably employed to track the publications subscribed to by the user so that the user can be billed for the publications received.

In many cable television systems, services such as video-on-demand are provided over the cable network. This entails the user sending a request for a program upstream over the cable network. The headend then receives the request and transmits the requested program downstream over the cable network. A billing system also registers the transmission of the requested program to the user and adds a charge to the user's account.

This model can be expanded under the principles of the present invention to monitor the publications downloaded over the broadcast system by a user. The billing service (452) then charges the user's account for those publications and generates a periodic bill to the user. Again, revenue received from the billing service (452) is provided in whole or in part to the publisher (301).

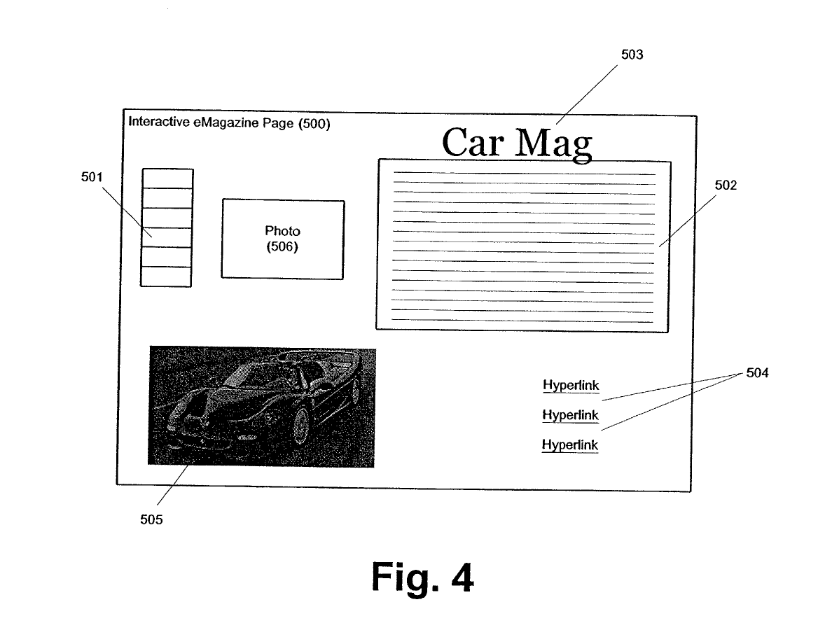

FIG. 4 illustrates an exemplary page (500) from an electronic publication under the principles of the present invention. The example of FIG. 4 is an eMagazine of which the subject matter is automobiles. The page (500) of the publication may have a masthead (503), text (502) and photographs (506). These are the elements of a traditional publication. The publication (500) may also have an interactive menu (501) so that the user can skip quickly to different parts of the publication. The publication (500) may also include hyperlinks (504) that reference related information or activities at various Internet sites as described above.

The publication (500) may also include links to supplemental material contained within the publication. For example, an audio or video clip contained in the publication may be played by selecting a hyperlink (504). Alternatively, and preferably, a video clip available as part of the publication may be represented by a picture (505) which is also a hyperlink and which, when selected, plays the specified video clip for the user.

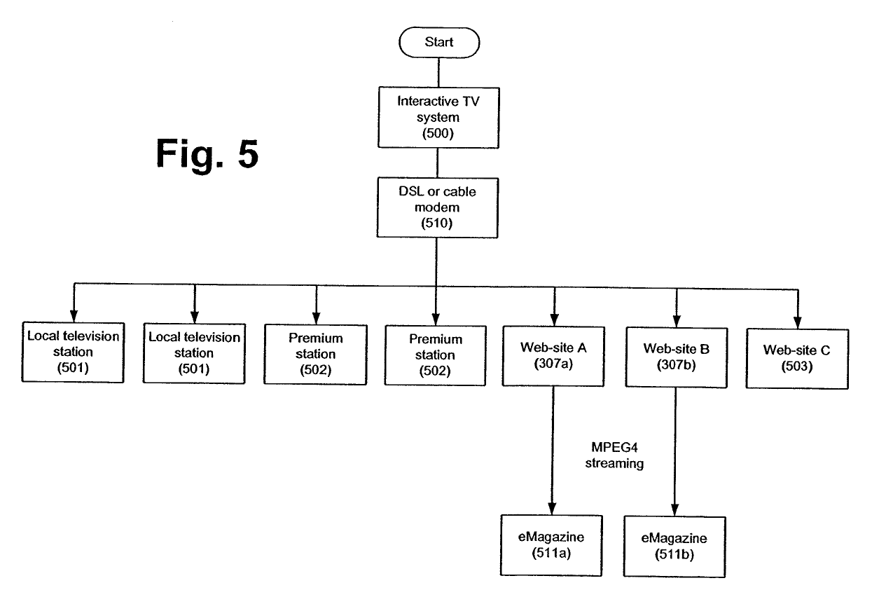

FIG. 5 illustrates a second embodiment of the present invention. In the second embodiment of the present invention, the PVR is replaced with an interactive television or ITV device. The ITV device (500) is a particular type of television peripheral device that allows the user to access television channels or sites on a data network, e.g., web-sites. The ITV device may be a separate unit or incorporated into a television set. Like the PVR described above, the ITV device receives a television signal and also has access to a data network, such as the Internet, and the capability to browse or retrieve data from the network, for example, an Internet browser. Preferably, the ITV device has a DSL or cable modem (510) for accessing the Internet.

The principal differences between a PVR and an ITV device may only be the ability to record data in digital form and the treatment of network sites at the same level as television channels. Data recording capability is not required of an ITV device, but is part of the definition of a PVR. Because a PVR may have a data network connection, a PVR can function as an ITV device with the additional capability of recording data.

As shown in FIG. 5, the ITV device may display local television channels (501), premium television channels (502) and network sites, e.g., web-sites, (307a, 307b, 503). Some of those network sites (307a, 307b) may provide electronic publications, e.g., eMagazines (511a, 511b), that can be streamed to the ITV device on request. Preferably, the streaming is MPEG4 streaming.

With streamed data, the data is typically not stored in retrievable form on the receiving device, computer or ITV device. Rather, the data is used as received, like a conventional television broadcast, and is then no longer accessible. By streaming the eMagazine or other electronic publication to the end user using an ITV or similar device, the publisher is better able to control unauthorized reproduction of the publication contents by the end user and can, perhaps, more easily extract payment for the publication from its recipients.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A television signal comprising:
television programming; and
an electronic publication.

2 The television signal of claim 1, wherein said signal is digital.

3. The television signal of claim 1, wherein said signal is analog.

4. The television signal of claim 1, wherein said electronic publication comprises at least one hyperlink referencing a site on an electronic data network.

5. The television signal of claim 1, wherein said electronic publication comprises an embedded video clip.

6. The television signal of claim 1, wherein said electronic publication comprises an embedded audio clip.

7. A method of distributing an electronic publication, said method comprising:
incorporating data for said electronic publication in a television signal along with television programming; and
broadcasting said television signal to users.

8. The method of claim 7, further comprising:
receiving said television signal; and
extracting said electronic publication from said television signal.

9. The method of claim 8, further comprising recording said electronic publication for later retrieval.

10. The method of claim 9, further comprising controlling access and output of said electronic publication to a video monitor with a user input device.

11. The method of claim 7, further comprising embedding at least one of a hyperlink referencing a data network site, a video clip or an audio clip in said electronic publication.

12. The method of claim 11, further comprising accessing said referenced network site upon selection of said hyperlink.

13. The method of claim 7, further comprising billing recipients for said electronic publication.

14. The method of claim 7, further comprising ordering said electronic publication.

15. A system for distributing an electronic publication, said system comprising:
a television signal broadcasting headend, wherein a television signal broadcast from said headend comprises television programming and an electronic publication; and
a personal video recorder for extracting said electronic publication from said television signal for use by a user.

16. The system of claim 15, wherein said personal video recorder further comprises a digital data storage device for recording said electronic publication.

17. The system of claim 16, wherein said digital data storage device is a hard disk drive.

18. The system of claim 15, wherein said personal video recorder further comprises a connection to the Internet and an Internet browser.

19. The system of claim 15, wherein said electronic publication further comprises at least one hyperlink referencing a site on an electronic data network to which said personal video recorder is connected.

20. The system of claim 15, further comprising a remote control unit for controlling said personal video recorder to access and output said electronic publication to a video monitor connected to said personal video recorder.

21. The system of claim 15, wherein said personal video recorder further comprises an external data connection for downloading said electronic publication to a computer or personal digital assistant.

22. The system of claim 15, wherein said broadcasting headend further comprises a subscriber billing system for tracking distribution of electronic publications and billing recipients for said electronic publications.

23. A system for distributing an electronic publication, said system comprising:
first means for broadcasting a television signal comprising both television programming and an electronic publication; and
second means for receiving said television signal and extracting said electronic publication from said television signal for use by a user.

24. The system of claim 23, wherein said second means further comprise means for recording said electronic publication.

25. The system of claim 24, wherein said means for recording comprise a hard disk drive.

26. The system of claim 23, wherein said second means further comprise a connection to an electronic data network.

27. The system of claim 26, wherein said electronic publication further comprises at least one hyperlink referencing a site on said network.

28. The system of claim 23, further comprising means for controlling said second means to access and output said electronic publication to a video monitor connected to said second means.

29. The system of claim 23, wherein said second means further comprises means for downloading said electronic publication to a computer or personal digital assistant.

30. The system of claim 23, wherein said first means further comprise means for tracking distribution of electronic publications and billing recipients for said electronic publications.

31. A system for distributing an electronic publication, said system comprising:
an interactive television device for providing access to both broadcast television channels and sites on the Internet, wherein said interactive television device comprises web browsing and video software for receiving streamed data from the Internet; and
a connection for connecting said interactive television device and the Internet.

32. The system of claim 31, further comprising an electronic publication resident at an Internet site accessible to said interactive television device;
wherein said electronic publication is streamed to said interactive television device via the Internet.
